(19) United States
(12) Patent Application Publication
(10) Pub. No.: US 2026/0236832 A1
(43) Pub. Date: Aug. 13, 2026

(54) A Method of Re-Baselining a Plurality of AI Models and System Thereof

(71) Applicants: Robert Bosch GmbH, Stuttgart (DE); Bosch Global Software Technologies Private Limited, Bangalore (IN)

(72) Inventors: Amlan Jyoti, Odisha (IN); Manojkumar Somabhai Parmar, Ahmedabad, Gujarat (IN); Pavan Kulkarni, Karnataka (IN); Govindarajulu Yuvaraj, Bengaluru, Karnataka (IN)

(21) Appl. No.: 19/151,479

(22) PCT Filed: Jan. 26, 2024
(86) PCT No.: PCT/EP2024/051962

§ 371 Date: Jul. 28, 2025

(30) Foreign Application Priority Data
Jan. 30, 2023 (IN) 202341005915

(51) Int. Cl. G06N 20/00

(52) U.S. Cl. CPC G06N 20/00

(57) ABSTRACT

A method of re-baselining a plurality of AI Models and a system thereof is disclosed. The plurality of AI Models reside in a plurality of independent edge devices where they self-learn. The system is designed to detect poisoning in AI models amongst the plurality of AI Models and then select a group of non-poisoned AI models to perform federated learning on the selected group of non-poisoned AI models to get a re-baselined Model. Finally, the re-baselined Model is pushed into the plurality of edge device using firmware over the air.

### APPLICANTS

The following specification describes and ascertains the nature of this invention and the manner in which it is to be performed.

### FIELD OF THE INVENTION

The present disclosure relates to the field of AI security and over the air programming. In particular, the present invention discloses A method of re-baselining a plurality of AI models and system thereof.

### BACKGROUND OF THE INVENTION

In its nascent phase, Artificial intelligence (AI) has been deployed in the cloud as AI algorithms process massive amounts of data and consume massive computing resources. But as AI technology has progressed many of its applications require AI-based data crunching and decisions need to be made locally, on devices that are close to the edge of the network. Hence AI systems are migrating towards the edge from the cloud today. AI in the edge devices allows critical and time-sensitive decisions to be made faster, more reliably and with greater security despite of unstable network connectivity. The need to push AI to the edge is also being fueled by the rapid growth of edge devices such as smartphones, smart wearables and sensors monitoring machines and infrastructure. Hence, learnings are shifting from a centralized lab or a cloud to real-life situations on edge devices. This natural evolution is causing devices to self-learn in the field.

Although this AI technology evolution is making latency low and processing faster, we are witnessing issues in self-learning. The systems that learn from their environment in the field do not have a mechanism to differentiate appropriate learning from inappropriate learning (anomalous learning). The AI does not have its own consciousness to differentiate the good learning from bad. One such well-known example was the case of Microsoft chatbot which started abusing people.

Another major possibility that forms the primary focus of this invention is the poisoning of AI models on edge devices (i.e. the local model). It is possible that one of the local models is poisoned by the participant. Adversarial data poisoning is defined as an effective attack against machine learning and threatens model integrity by introducing poisoned data into the training dataset. Since the AI model learns on poisoned dataset, it is bound to give incorrect results. When the poisoned local model is used for re-training or re-baselining the versions of a global, the global model is also poisoned. When this poisoned global model is sent back to all edge devices, the participants are also eventually poisoned resulting in security issues in multiple edge devices. Therefore, there is a need to check the quality of learning and take appropriate actions. Failure to do can also result in product liability when products are making decisions that are not helpful for end-users and society. Hence, it is necessary to perform a poisoning detection on the local model before using them for re-baselining using federated learning.

Patent application US20170048308A1 titled “System and Apparatus for Network Conscious Edge to Cloud Sensing, Analytics, Actuation and Virtualization” discloses a method and apparatus for network conscious edge-to-cloud data aggregation, connectivity, analytics and actuation operate for the detection and actuation of events based on sensed data, with the assistance of edge computing software-defined fog engine with interconnect with other network elements via programmable internet exchange points to ensure end-to-end virtualization with cloud data centers and hence, resource reservations for guaranteed quality of service in event detection.

### BRIEF DESCRIPTION OF THE ACCOMPANYING DRAWINGS

An embodiment of the invention is described with reference to the following accompanying drawings:

FIG. 1 depicts a system (10) deployed for re-baselining a plurality of AI Models (102);

FIG. 2 illustrates method steps (200) for re-baselining a plurality of AI Models (102);

FIG. 3 illustrates method steps (203) for detecting poisoning in the plurality of AI Models (102).

### DETAILED DESCRIPTION OF THE DRAWINGS

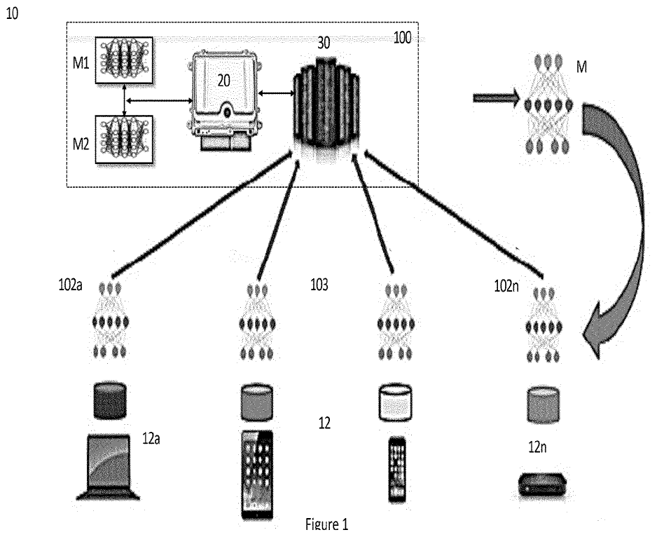

FIG. 1 depicts a system (10) deployed for re-baselining a plurality of AI Models (102) residing in a plurality of edge devices (12). The plurality of AI Models (102) reside in a plurality of edge devices (12a . . . 12n), where they are adapted to self-learn. The system (10) for re-baselining a plurality of AI Models (102) comprises a processor (20), a global aggregator database (30) and at least two clean AI models. The global aggregator database (30) is a form of storage module where each self-learned model is stored along with its metadata like device id, model id, device type, model pulled time stamp and other relevant parameters.

The plurality of edge devices (12) are independent devices that are connected to a network via an interface. With reference to this disclosure the network acts as a bridge between the plurality of independent devices and the processor (20) of the control system (10). An edge device is defined as any component responsible for connecting with the network. In simple terms an edge device can be anything (102a to 102n) from a smartphone, laptop to a router which connects to the internet. The plurality of AI Models (102) reside in the plurality of independent edge devices (12). During re-baselining the AI models are re-trained and re-learn.

An AI model with reference to this disclosure can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. A person skilled in the art will also appreciate that the AI models may be implemented as a set of software instructions, combination of software and hardware or any combination of the same.

Typically, the AI models used in these edge devices (12) are involved in speech recognition, natural language processing, audio recognition, autonomous driving, etc. where they process data to generate required output based on certain rules/intelligence acquired through training. To process the inputs and give a desired output, the AI system (10) s use various models/algorithms which are trained using the training data. Once the AI system (10) is trained using the training data, the AI system (10) s are deployed along with self-learning mechanism. The deployed AI system (10) s use the self-learning mechanism within AI models to analyze the real time data and generate appropriate result. In this process they self-learn on the real time data. In accordance with the present disclosure each of the plurality of the plurality of edge devices (12) run a specified version of the AI model.

The at least two clean AI models (M1, M2) have the same architecture as the plurality of AI Models (102) in the edge devices (12). However, the clean AI models are trained using a non-manipulated and trusted dataset.

The processor (20) can either be a logic circuitry or a software programs that respond to and processes logical instructions to get a meaningful result. A hardware processor (20) may be implemented in the system (10) as one or more microchips or integrated circuits interconnected using a parent board, hardwired logic, software stored by a memory device and executed by a microprocessor (20), firmware, an application specific integrated circuit (ASIC), and/or a field programmable gate array (FPGA).

The processor (20) disclosed in accordance with this disclosure is configured to extract the plurality of AI Models (102) from the edge devices (12) to a global aggregator database (30); detect poisoning in AI models amongst the plurality of AI Models (102); select a group of non-poisoned AI models from the plurality of AI Models (102) by means of the processor (20); perform federated learning on the selected group of non-poisoned AI models to get a re-baselined Model (M); push the re-baselined Model (M) into the plurality of edge devices (12) using firmware over the air.

While detecting poisoning the processor (20) is configured to feed a manipulated dataset to the plurality of AI Models (102) to get a plurality of first set of outputs comprising output from each layer of the plurality of self-learned AI models; feed the manipulated dataset to said at least two clean AI models (M1, M2) to get a second set of outputs and a third set of outputs respectively for each layer of the said two clean AI models (M1, M2); compute distance D1 between the first set of outputs and the second set of outputs using Lp norm; compute a distance D2 between the first set of outputs and the third set of outputs using Lp norm; compute a distance D3 between the second set of outputs and the third set of outputs using Lp norm; analyze the calculated distances D1, D2, D3 to detect poisoning in any of the self-learnt AI Models. The processor (20) computes a set ratios for mean of distances (D1,D2,D3) and compares it to a pre-defined threshold.

As used in this application, the terms “component,” “system (10),” “interface,” “model,” “module” are intended to refer to a computer-related entity or an entity related to, or that is part of, an operational apparatus with one or more specific functionalities, wherein such entities can be either hardware, a combination of hardware and software, software, or software in execution. By way of illustration, both an application running on a server and the server can be a component. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor (20), wherein the processor (20) can be internal or external to the apparatus and executes at least a part of the software or firmware application. As further yet another example, interface(s) can include input/output (I/O) components as well as associated processor (20), application, or Application Programming Interface (API) components.

It should be understood at the outset that, although exemplary embodiments are illustrated in the figures and described below, the present disclosure should in no way be limited to the exemplary implementations and techniques illustrated in the drawings and described below.

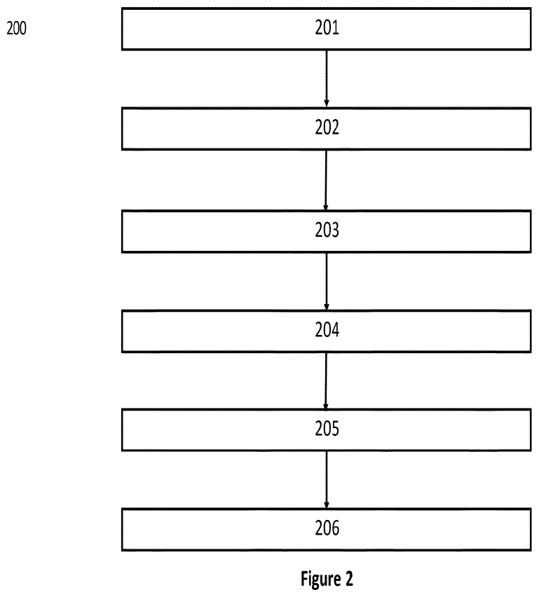

FIG. 2 illustrates method steps for re-baselining a plurality of AI Models (102). The system (10) for re-baselining plurality of AI Models (102) and its components have been explained in accordance with FIG. 1. It is reiterated that the system (10) for re-baselining a plurality of AI Models (102) comprises a processor (20), a global aggregator database (30) and at least two clean AI models.

In method step 201, the processor (20) extracts the plurality of AI Models (102) from the edge devices (12) to a global aggregator database (30). The extraction happens over a network such as internet. In method step 202, two clean AI models (M1, M2) are trained using non-manipulated dataset. In another embodiment of the present disclosure, the two clean AI models are pre-trained. The models are trained to perform similar tasks as the plurality of AI Models (102).

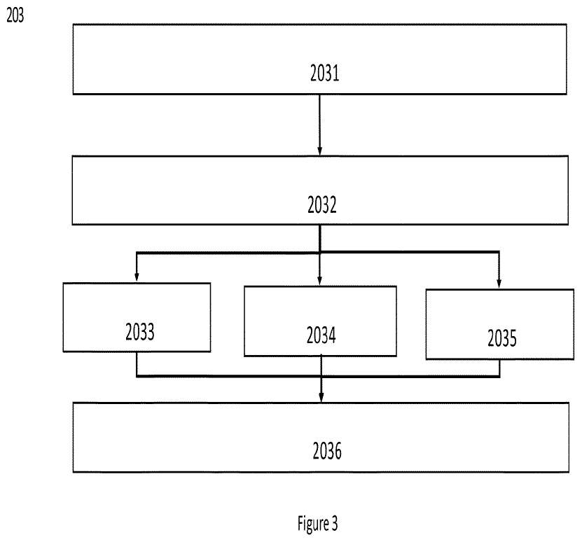

In method step 203, the processor (20) detects poisoning in AI models amongst the plurality of AI Models (102). FIG. 3 illustrates method steps of detecting poisoning in the plurality of AI Models (102). Detecting poisoning further comprises the following steps. Method step 2031 comprises feeding a manipulated dataset to the extracted plurality of AI Models (102) to get a plurality of first set of outputs comprising output from each layer of the plurality of AI Models (102). Method step 2032 comprises feeding the manipulated dataset to said at least two clean AI models (M1, M2) by means of the processor (20) to get a second set of outputs and a third set of outputs respectively for each layer of the said two clean AI models (M1, M2).

Since, poisoned model behaves in the similar fashion as to clean model when given clean input whereas it behaves differently compared to clean models only when given manipulated dataset. The manipulated data can either be fetched from a database (30) or generated by the processor (20). In an exemplary embodiment of the present invention, manipulated dataset is generated by the processor (20) that is similar to poisoned data to distinguish poisoned models from clean models.

$$Manipulated dataset = alpha * x + ( 1 - alpha ) * Gaussian Noise , where alpha = [ 0 , 1 ] , x\_clean is a clean input dataset and alpha is a randomly selected scaling factor$$

For an AI model trained for image classification this can be expressed as lets us assume patched image dataset was used to poison the AI model, then

$$Patched\_img = mask * noisy\_input + ( 1 - masked ) * Gaussian Noise , where mask can be any random squares with random values .$$

Method step 2033 comprises computing distance D1 between the first set of outputs and the second set of outputs using Lp norm by means of the processor (20). Method step 2034 comprises computing a distance D2 between the first set of outputs and the third set of outputs using Lp norm by means of the processor (20). Method step 2035 comprises computing a distance D3 between the second set of outputs and the third set of outputs using Lp norm by means of the processor (20).

In mathematics, the Lp spaces are function spaces defined using a natural generalization of the p-norm for finite-dimensional vector spaces.
D1=Distance calculated using Lp Norm for the output of the i-th layer of the first clean AI model and one of the plurality of AI Models (102). (Example:)

$$Lp ( outM 1 [ i ] - outM [ i ] ) \sqrt{Lp} ( outM 1 [ i ] * Lp ( outM [ i ]$$

D2=Distance calculated using Lp Norm for the output of the i-th layer of the second clean AI model and one of the plurality of AI Models (102). (Example:)

$$Lp ( outM 2 [ i ] - outM [ i ] ) \sqrt{Lp} ( outM 2 [ i ] * Lp ( outM [ i ]$$

D3=Distance calculated using Lp Norm for the output of the i-th layer of the Clean AI models (M1, M2). (Example:)

$$Lp ( outM 1 [ i ] - outM 2 [ i ] ) \sqrt{Lp} ( outM 1 [ i ] * Lp ( outM 2 [ i ]$$

Method step 2036 comprises analyzing the calculated distances D1,D2, D3 by means of the processor (20) to detect poisoning in any of the plurality of AI Models (102). Analysis to detect poisoning further comprises computing a set ratios for mean of distances (D1,D2,D3) and comparing it to a pre-defined threshold. The step 203 is repeated multiple times for the each of the plurality of the AI models. We compare the distance between all 3 models (two clean and one from the plurality of self-learnt AI model) using a rule-based decision. The rationale behind comparing these distance is that the distance between the output of a poisoned model and the output of a clean model vis-à-vis the distance between outputs of two clean models when fed a manipulated dataset will show a remarkable difference.

In method step 204 the processor (20) selects a group of non-poisoned AI models from the plurality of AI Models (102). In method step 204 the processor (20) performs federated learning on the selected group of non-poisoned AI models to get a re-baselined Model (M). Federated Learning enables the group of selected AI models to collaboratively learn a shared model (re-baselined Model (M)). Federated learning enables building a common re-baselined and robust machine learning model that encompasses all the good learnings to address critical issues while eliminating the learnings of the poisoned AI models.

In method step 205, the processor (20) pushes the re-baselined Model (M) into the plurality of edge device using firmware over the air. Before the models are pushed backed using Firmware over the air (FOTA), they also go through hardware specific model optimization and software specific model optimization. Hardware specific model optimization is the fine tuning of the re-baselined AI Model (M) done in accordance with the hardware specific requirements of the edge device such as generalized hardware optimization and multiple target hardware optimization.

This idea to develop a method of re-baselining a plurality of AI Models (102) and a system (10) thereof basically ensures that only non-poisoned models which are self-learning in the field (edge AI) are brought back and re-baselined. This regulates the quality of learning in the field/edge devices (12) ensuring accountability for the product manufactures. The core idea of the invention is poisoning detection before aggregation to prevent potential poisoning of the Global Model in a federated learning setup. It must be understood that the disclosure in particular discloses methodology used to re-baseline a plurality of AI Models (102) residing in a plurality of independent edge devices (12). While these methodologies describes only a series of steps to accomplish the objectives, these methodologies are implemented in the system (10), which may be modified according to the requirements.

It must be understood that the embodiments explained in the above detailed description are only illustrative and do not limit the scope of this invention. Any modification or customization of the method of re-baselining a plurality of AI Models (102) and system (10) thereof are envisaged and form a part of this invention. The scope of this invention is limited only by the claims.

1. A method of re-baselining a plurality of AI Models, said plurality of AI Models residing in a plurality of independent edge devices, said AI models being configured to self-learn in the respective edge devices, the method comprising:
extracting the plurality of AI Models from the edge devices to a global aggregator database by way of a processor;
training at least two clean AI models having the same architecture as the plurality of AI Models using a non-manipulated dataset;
detecting poisoning in AI models amongst the plurality of AI Models;
selecting a group of non-poisoned AI models from the plurality of AI Models by way of the processor;
performing federated learning on the selected group of non-poisoned AI models to get a re-baselined Model; and
pushing the re-baselined Model into the plurality of edge devices using firmware over the air.

2. The method as claimed in claim 1, wherein detecting poisoning further comprises:
feeding a manipulated dataset to the extracted plurality of AI Models to get a plurality of first set of outputs comprising output from each layer of the plurality of AI Models;
feeding the manipulated dataset to the at least two clean AI models by way of the processor to get a second set of outputs and a third set of outputs respectively for each layer of the two clean AI models;
computing a distance D1 between the first set of outputs and the second set of outputs using Lp norm by way of the processor;
computing a distance D2 between the first set of outputs and the third set of outputs using Lp norm by way of the processor;
computing a distance D3 between the second set of outputs and the third set of outputs using Lp norm by way of the processor; and
analyzing the calculated distances D1, D2, D3 by way of the processor to detect poisoning in any of the plurality of AI Models.

3. The method as claimed in claim 1, wherein analysis to detect poisoning further comprises computing a set of ratios for mean of distances and comparing it to a pre-defined threshold.

4. A system for re-baselining a plurality of AI Models, the system comprising a processor and at least a global aggregator database, the plurality of AI Models residing in a plurality of edge devices, the AI models being configured to self-learn in the plurality of edge devices, wherein the system further comprises at least two clean AI models having the same architecture as the plurality of AI Models, said clean AI models trained using a non-manipulated dataset, wherein the processor is configured to:
extract the plurality of AI Models from the edge devices to a global aggregator database;
detect poisoning in AI models amongst the plurality of AI Models;
select a group of non-poisoned AI models from the plurality of AI Models;
perform federated learning on the selected group of non-poisoned AI models to get a re-baselined Model; and
push the re-baselined Model into the plurality of edge devices using firmware over the air.

5. The system as claimed in claim 4, wherein the processor while detecting poisoning in the plurality of self-learnt AI Models is configured to:
feed a manipulated dataset to the plurality of AI Models to get a plurality of first set of outputs comprising output from each layer of the plurality of self-learned AI models;
feed the manipulated dataset to said at least two clean AI models to get a second set of outputs and a third set of outputs respectively for each layer of the two clean AI models;
compute a distance D1 between the first set of outputs and the second set of outputs using Lp norm;
compute a distance D2 between the first set of outputs and the third set of outputs using Lp norm;
compute a distance D3 between the second set of outputs and the third set of outputs using Lp norm; and
analyze the calculated distances D1, D2, D3 to detect poisoning in any of the self-learnt AI Models.

6. The system as claimed in claim 4, wherein analysis to detect poisoning further comprises the processor computing a set ratios for mean of distances and comparing it to a pre-defined threshold.
